(19) United States
(12) Patent Application Publication
(10) Pub. No.: US 2026/0344669 A1
(43) Pub. Date: Nov. 5, 2026

(54) CONCENTRATED AGROCHEMICAL COMPOSITIONS OF ANTHRANILIC DIAMIDES

(71) Applicant: ADAMA MAKHTESHIM LTD., Beer Sheva (IL)

(72) Inventors: Yohai DAYAGI, Kibbutz Kramim (IL); Alexandra KABALIK, Beer Sheva (IL)

(73) Assignee: ADAMA MAKHTESHIM LTD., Beer Sheva (IL)

(21) Appl. No.: 19/116,053

(22) PCT Filed: Sep. 27, 2023
(86) PCT No.: PCT/IL2023/051037

§ 371 Date: Mar. 27, 2025

Related U.S. Application Data
(60) Provisional application No. 63/411,164, filed on Sep. 29, 2022.

(51) Int. Cl. A01N 43/56; A01N 25/04; A01N 25/30; A01P 7/04

(52) U.S. Cl. CPC A01N 43/56; A01N 25/04; A01N 25/30; A01P 7/04

(57) ABSTRACT

The present invention provides an agrochemical suspension concentrate composition comprising: a) more than 40% of diamide per weight of total composition; b) silicone surfactant; c) polyelectrolyte block copolymer; d) sulfonate surfactant; e) water. In addition, the present invention is directed to a method for controlling an arthropod pest, comprising diluting a suspension concentrate composition comprising: a) more than 40% of diamide per weight of total composition; b) silicone surfactant; c) polyelectrolyte block copolymer; d) sulfonate surfactant; e) water; with water, and optionally adding an adjuvant to form a diluted composition, and contacting the arthropod pest or its environment with an effective amount of said diluted composition.

### FIELD OF INVENTION

The present invention relates to agrochemical suspension concentrate compositions containing more than 40% per weight of diamides, their preparation and use as crop protection agents.

### BACKGROUND

Anthranilic diamides belong to a synthetic class of insecticides characterized by selective binding to the ryanodine receptor of insect. Based on that, anthranilic diamides suggested as reduced-risk insecticides, with low toxicity to vertebrates and non-target organisms, having root systemic and translaminar activity against a broad spectrum of sucking and chewing insects. Anthranilic diamides have low solubility in water and can be formulated in a dissolved form to provide stable emulsions, only if large amount of heavy organic solvents utilized. Therefore, water-based compositions, namely, suspension concentrates, comprising solid anthraniic diamides dispersed in water are of interest. Suspension concentrates, when compared to other liquid formulation types have the added advantage of not requiring the use of organic solvents, present in emulsifiable concentrates and soluble liquid concentrates. However, while emulsifiable concentrates and soluble liquid concentrates are monophase systems, aqueous suspension concentrates of solid active substances are two-phase systems (solid/liquid), which generally are less stable and tend to separation; this tendency increasing with increasing storage time and storage temperature. Moreover, as the amount of solid active ingredient concentration in suspension concentrate increases, high tendency of agglomeration of organic solid, and high viscosity observed. Selection of proper stabilization surfactants, maintaining low viscosity and efficient wetting of organic solid becomes critical with increased amount of organic solid in suspension concentrates, since the space available in the formulation for partitioning (between increasing solid surface area and decreasing aqueous media) becomes less. Therefore, there is a need for new optimal surfactants system leading to formation of stable suspension concentrates having high concentration of organic solid active and showing improved bioefficacy on agrochemical applications.

### SUMMARY

The present invention provides an agrochemical suspension concentrate composition comprising: a) more than 40% of diamide per weight of total composition; b) silicone surfactant; c) polyelectrolyte block copolymer; d) sulfonate surfactant; e) water.

In particular, the present invention provides an agrochemical suspension concentrate composition, comprising: a) more than 40% of diamide per weight of total composition; b) 0.1 to 5.0% of silicone surfactant; c) 1.0 to 10% of polyelectrolyte block copolymer; d) 1.0 to 10% of sulfonate surfactant; e) water.

In another aspect, the present invention provides a method for controlling an arthropod pest, comprising diluting a suspension concentrate composition comprising: a) more than 40% of diamide per weight of total composition; b) silicone surfactant; c) polyelectrolyte block copolymer; d) sulfonate surfactant; e) water; with water, and optionally adding an adjuvant to form a diluted composition, and contacting the arthropod pest or its environment with an effective amount of said diluted composition.

In addition, the present invention provides a method for the protection of plant propagation material from the attack by a pest such as an insect, comprising treating the propagation material or the site where the propagation material is to be planted with an effective amount of a composition comprising: a) more than 40% of diamide per weight of total composition; b) silicone surfactant; c) polyelectrolyte block copolymer; d) sulfonate surfactant; e) water.

### DESCRIPTION OF INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application.

As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

The term “stabilizer” as used herein refers but not limited to a chemical agent that is added to a composition and exhibiting a satisfactory stabilization effect on the combination of other inert and active ingredient/s contained in the present agricultural chemical composition, without any adverse influence on the physical properties of the composition.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “suspension concentrate composition” refers to compositions comprising finely divided solid particles of an active ingredient/s dispersed in water or organic liquid. Said particles preserve chemical and physical identity and can be physically separated from liquid.

As used herein, the term “insecticide” broadly refers to compounds or compositions that are used as acaricides, insecticides, insecticide synergists, ixodicides, nematicides, and molluscicides. For chemical classes and applications, as well as specific compounds of each class, see “The Pesticide Manual Thirteenth Edition” (British Crop Protection Council, Hampshire, U K, 2003), as well as “The e-Pesticide Manual, Version 3” (British Crop Protection Council, Hampshire, U K, 2003-04), the contents of each of which are incorporated herein by reference in their entirety.

As used herein the term “plant” or “crop” refers, but is not limited to whole plants, plant organs (e.g. leaves, stems, twigs, roots, trunks, limbs, shoots, fruits etc.), plant cells, or plant seeds. This term also encompasses plant crops such as fruits and vegetables. In some embodiments, the term “plant” may include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein the term “plant propagation material” refers, but is not limited to, all the generative parts of the plant such as seeds and vegetative plant material such as cuttings and tubers, which can be used for the multiplication of the plant including tubers, spores, corms, bulbs, rhizomes, sprouts basal shoots, stolons, and buds and other parts of plants, including seedlings and young plants, which are to be transplanted after germination or after emergence from soil.

As used herein, the term “locus” refers, but is not limited to the place on which the plants are growing, the place on which the plant propagation materials of the plants are sown or the place on which the plant propagation materials of the plants will be sown including the areas under cultivation.

As used herein, the term “treating a plant or a locus against insect pest” includes, but is not limited to, protecting the plant or locus against insect pest and/or controlling insect pest of the plant or locus.

As used herein the term “ha” refers to hectare.

As used herein, the term “mixture” or “combination” refers, but is not limited to, a combination in any physical form, e.g., blend, solution, suspension or the like.

The term “hydrophobic” refers to having affinity to organic solvents, and which therefore do not dissolve in water or do so in negligible amounts. For example, hydrophobic compounds have a solubility of less than 1 g/L in water at 20 °C.

The term “hydrophilic” refers to species having affinity to water, and which therefore do not dissolve in organic solvents or do so in negligible amounts. The term “water soluble” is synonym of “hydrophilic”, and water soluble compounds have a solubility of more than 1 g/L in water at 20 °C.

As used herein, the phrase “block copolymer” means a polymer comprising at least two different polymers combined by a covalent bond. Each of the blocks is usually a homopolymer but can also be a copolymer with a specific distinct physical/chemical or functional characteristic (e.g., having one block that is easily soluble in water, with the other block being primarily insoluble in water). Therefore, the polyanionic block copolymer comprises at least one “hydrophilic moiety” and at least one “hydrophobic moiety”. Each of these moieties can be homopolymers or block copolymers themselves.

The aspects and embodiments of the present invention are described below.

The present invention provides an agrochemical suspension concentrate composition comprising: a) more than 40% of diamide per weight of total composition; b) silicone surfactant; c) polyelectrolyte block copolymer; d) sulfonate surfactant; e) water.

In an embodiment, the present invention provides an agrochemical suspension concentrate composition comprising: a) more than 40% of diamide per weight of total composition; b) 0.1 to 5.0% of silicone surfactant; c) 1.0 to 10% of polyelectrolyte block copolymer; d) 1.0 to 10% of sulfonate surfactant; e) water.

In an embodiment, the agrochemical suspension concentrate composition comprising a) from 41% to 60% of diamide per weight of total composition.

In another embodiment, the agrochemical suspension concentrate composition comprising a) from 45% to 60% of diamide per weight of total composition.

In an embodiment, the agrochemical suspension concentrate composition comprising a) from 49% to 60% of diamide per weight of total composition.

In an embodiment, the agrochemical suspension concentrate composition comprising a) from 49% to 55% of diamide per weight of total composition.

In an embodiment, the agrochemical suspension concentrate composition comprising a) from 50% to 52% of diamide per weight of total composition.

In an embodiment, the agrochemical suspension concentrate composition comprising a) from 55% to 60% of diamide per weight of total composition.

In an embodiment, the diamide is selected from chlorantraniliprole, cyantraniliprole, bromantraniliprole, tetrantraniliprole and the mixtures thereof.

In yet another embodiment, the ratio of silicone surfactant b) to polyelectrolyte block copolymer c) is from about 1:15 to 15:1.

In yet another embodiment, the ratio of silicone surfactant b) to polyelectrolyte block copolymer c) is from about 1:10 to 10:1.

In yet another embodiment, the ratio of silicone surfactant b) to polyelectrolyte block copolymer c) is from about 1:15 to 15:1.

In an embodiment, the ratio of polyelectrolyte block copolymer c) to the sulfonate surfactant d) is from about 1:10 to 10:1.

In an embodiment, the ratio of polyelectrolyte block copolymer c) to the sulfonate surfactant d) is from about 1:9 to 9:1.

In an embodiment, the ratio of polyelectrolyte block copolymer c) to the sulfonate surfactant d) is from about 1:6 to 6:1.

In an embodiment, the ratio of polyelectrolyte block copolymer c) to the sulfonate surfactant d) is from about 1:5 to 5:1.

In an embodiment, the ratio of polyelectrolyte block copolymer c) to the sulfonate surfactant d) is from about 1:3 to 3:1.

In an embodiment, the silicone surfactants include, but are not limited to polyalkylene-modified polymethylsiloxanes, polyether modified trisiloxanes, and the like. Suitable examples of silicone surfactants may include BreakThru® OE444, BreakThru® S240, available from Evonic Industries, Silwett® L77, and Silwett® 408 available from Momentive Performance Materials Inc.

In an embodiment, the silicone surfactants are those of formula A:

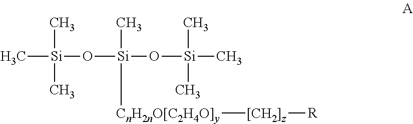

wherein n=2-4, y=3-10, z=0-5, and R═OH, H, C1-C4 alkyl.

In an embodiment, the polyelectrolyte block copolymer c) comprises (A) an anchoring moiety and (B) at least one stabilizing moiety.

In yet another embodiment, the polyelectrolyte block copolymer c) comprises at least 90% of the anchoring moiety (A) consisting of acrylate derivatives, methacrylate derivatives, styrene derivatives, and any combination thereof.

In an embodiment, the polyelectrolyte block copolymer c) comprises hydrophilic block copolymer as stabilizing moiety (B).

In an embodiment, the polyelectrolyte block copolymer c) comprises a stabilizing moiety (B) containing of at least 60% by weight of charged anionic monomers.

In an embodiment, the polyelectrolyte block copolymer c) could be prepared according to the methods described in WO2017098325.

In an embodiment, the polyelectrolyte block copolymer c) is a block copolymer comprising 77% of sodium 2-acryloylamino-2-methylpropane-I-sulfonate (AMPS) monomers and 23% of the ethyl acrylate (EA) monomers.

In an embodiment, the polyelectrolyte block copolymer c) is a water solution of 30% w/w solution of a block copolymer comprising 77% of sodium 2-acryloylamino-2-methylpropane-I-sulfonate (AMPS) monomers and 23% of ethyl acrylate (EA) monomers, which may be prepared as described in Example 1 of WO2017/098325.

In an embodiment, the polyelectrolyte block copolymer is PolyAgro A, which is a di-block copolymer, with a total weight of 17000 g/mol, composed of a hydrophobic block (Anchor block-ANCHOR) and a hydrophilic block (Stabilizing block-STAB). The stabilizing, hydrophilic, block is made of sodium 2-Acryloylamino-2-methylpropane-1-sulfonate (AMPS) monomers, which are 77% of the overall monomers in the polymer. The other 23% of the monomers belongs to the anchor, hydrophobic, block which is made of ethyl acrylate monomers. The total amount of monomers in the polymer (degree of polymerization, DPn) is 85 monomers.

The polyelectrolyte block copolymer PolyAgro A may be obtained according to the following procedure:

### a) Step 1

Into a 2 L double jacketed reactor equipped with mechanical agitator and reflux condenser was added 11.26 g of O-ethyl-S-(1-methoxycarbonylethyl) xanthate (CH3CH(CO2CH3))S(C═S)OEt), 264.08 g of Ethanol, and 356.32 g of De-ionized water and 1400 g of AMPS (Na) solution (50% active) and 1.52 g of 4,4′-Azobis(4-cyanopentanoic acid). The reactor contents were heated to 70 °C under agitation and nitrogen. The reaction mixture was aged at 70 °C for a further hour whereupon it was cooled to ambient temperature and discharged. The measured solids content was 37.6% (115 °C, 60 mins). GPC Mals: Mn=16300 Mw=2600 IP=1.6.

### b) Step 2

Into a 5 L double jacketed reactor equipped with mechanical agitator and reflux condenser was added 2127 g of solution prepared in Step 1 and 330 g of de-ionized water. The reactor contents were heated to 70 °C under agitation and a nitrogen stream. Once 70 °C was reached, 106.67 g of ethyl acrylate (EA) was added over 2 hours and a 37.37 g of a solution of 10 wt % of 4,4′-Azobis(4-cyanopentanoic acid) was concomitantly added over 2 hours. After the end of the introduction of the initiator solution, the reaction solution was further aged for one hour. Thereafter a shot of 44.85 g of a 10 wt % solution of 4,4′-Azobis(4-cyanopentanoic acid) was added and the mixture aged at 70 °C for a further hour whereupon it was cooled to ambient temperature and discharged. The measured solids content was 40.0% (115 °C, 60 mins). Then ethanol was removed from the polymer solution using a rotary evaporator. Water was back added to achieve a polymer solution with a final solids content of 40.4%.

2600 g of polymer solution was placed in a 5 L double jacketed reactor equipped with mechanical agitator and reflux condenser. The pH of the solution was increased to 8.5 using a 50% solution of NaOH. The mixture was heated to 70 °C with stirring whereupon 48.4 of a 30% solution of hydrogen peroxide was added in 1 hour. At the end of the additions, the solution was aged for a further 3h00 whereupon it was cooled and discharged. The residuals monomers were measure by HPLC and GC (AMPS=22 ppm, EA=2 ppm). The measured solids content was 37.5%. The polymer is used in the composition of the present invention as a ready aqua polymer solution at concentration of about 30% w/w.

In an embodiment, the sulfonate surfactant d) is selected from aryl sulfonates, alkyl aryl sulfonates, lignosulfonates, naphthalene sulfonates, alkylnathalene sulfonates, benzylsulfonates, alkylbenzene sulfonates and the mixtures thereof.

In an embodiment, the sulfonate surfactants include, but are not limited to alkyl naphthalene formaldehyde condensate sulfonate of the formula:

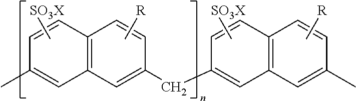

wherein
R is independently hydrogen, a C₁₋₁₅ straight or branched chain alkyl or alkenyl group; X is independently hydrogen, an alkali metal, an alkaline earth metal, ammonium, a mono-, di-, or tri-C₁₋₄ alkyl ammonium, or a mono-, di- or tri-C₁₋₄ hydroxyalkyl ammonium moiety.

n is from 1 to 25.

R groups can be present in any position on the naphthalene nucleus.

Suitable examples of naphthalene sulfonate condensates may include Morwet D-425, Morwet D-500, Morwet D-809 available from NOURYON, Tersperse 2020 available from Indroma and Surfom WG 8168 available from Oxiteno.

In another embodiment, the agrochemical suspension concentrate composition further comprises an additive selected from selected from the group comprising dispersants, thickeners, antifreezing agents, antifoaming agents, preservatives, pH modifiers and stabilizers.

Non-limiting examples of dispersants are selected from the group consisting of sodium bis(2-ethylhexyl) sulfosuccinate, sorbitan mono-9-octadecanoate poly(oxy-1,2-ethanediyl) derivatives and their complex mixtures of polyoxyethylene ethers; grafted copolymers comprising a poly(methyl methacrylate/methacrylic acid) backbone and polyethylene oxide side chains, ethoxylated tristyrylphenol, ethoxylated tristyrylphenol phosphate esters, poly(oxyethylene)-poly(oxypropylene)-poly(oxyethylene) polymers, (ethyleneoxide-propyleneoxide) butyl-ether di-block polymers, and oligomeric D-glucopyranose.

Non-limiting examples of commercial thickeners can be used, for instance, those based on polysaccharides, such as methylcellulose, carboxymethylcellulose, hydroxypropyl-cellulose, Xanthan Gum, synthetic polymers such as acrylic acid polymers, polyvinyl alcohol or polyvinyl pyrrolidones, silicic acid or phyllosilicates such as montmorillonites, attapulgites and bentonites, which may be hydrophobized. The concentration of thickeners in the agrochemical suspension concentrate composition may be lower or equal to 2% by weight, or it may be from 0.01 to 2% by weight, from 0.02 to 1.5% by weight, or from 0.1 to 1% by weight, based on the total weight of the composition.

The term “anti-foaming agent” as used herein refers to a chemical agent that is added to a composition so as to prevent, attenuate, or counter foam generation in the composition. Generally, such agents have surface active properties, are insoluble in the foaming medium, easily spreadable on the foamy surface, possess affinity to the air-liquid surface, and destabilize the foam lamellas which rupture the air bubbles and break down the surface foam.

Non-limiting examples of anti-foaming agents include a mixture of alkenes, C11-C12, hydroformylation products, low boiling, or a commercially available product comprising it such as Geronol AF 80; a mineral oil-based defoamer or a commercially available product comprising it such as Lucrafoam® PDT; a blend of special wax, hydrophobic silica, and mineral oil or a commercially available product comprising it such as DEE FOR 3010E/50; a silicon emulsion or a commercially available product comprising it such as Silfoam® SE 47, Silfoam® SRE, Silcolapse® RG 12, and SAG 1572; a polydimethyl siloxane emulsion or a commercially available product comprising it such as SAG 10E; SAG-1538, Rhodorsil 432, or a silicone-based compound or a commercially available product comprising it such as Silcolapse™ 910 and Xiameter® ACP-1000.

In certain embodiments, the anti-foaming agent comprised within the composition of the invention constitutes from about 0.5% to about 3%, e.g., from about 0.75% to about 2.5%, from about 1% to about 2%, from about 1.25% to about 1.75%, or about 1.5%, by weight of said composition.

In certain embodiments, agrochemical suspension concentrate composition of the invention, as defined according to any one of the embodiments above, further comprises an anti-freeze agent.

Non-limiting examples of anti-freeze agents include (such as but not limited to glycerine, ethylene glycol, propylene glycol, monopropylene glycol, hexylene glycol, 1-methoxy-2-propanol, cyclohexanol).

In certain embodiments, the anti-freeze agent comprised within the composition of the invention constitutes from about 3% to about 10%, by weight of said composition.

The solid particles size in the inventive composition represented as d90-value, which has to be understood as the value that is not exceeded by the diameters of at least 90% by weight of the particles. The particle size of the solid substance particles (i.e. the diameters) can be determined by conventional methods such as light-scattering.

In an embodiment, the particle size distribution d90 of the solid particles present in the agrochemical suspension concentrate composition of the invention is less than 15 μm, more preferably from about 1 μm to 14 μm, and most preferably from about 3 μm to 13 μm.

In another embodiment, the particle size distribution d90 of the solid particles present in the agrochemical suspension concentrate composition of the invention is from about 3 μm to 10 μm.

In an embodiment, the agrochemical suspension concentrate composition of the present invention comprises an additional pesticidal active ingredient selected from abamectin, ABG-9008, acephate, acequinocyl, acetamiprid, acetoprole, acrinathrin, AKD-1022, AKD-3059, AKD-3088, alanycarb, aldicarb, aldoxycarb, allethrin, allethrin 1R isomers, alpha-cypermethrin (alphamethrin), amidoflumet, aminocarb, amitraz, avermectin, AZ-60541, azadirachtin, azamethiphos, azinphos-methyl, azinphos-ethyl, azocyclotin, Bacillus popilliae, Bacillus sphaericus, Bacillus subtilis, Bacillus thuringiensis, Bacillus thuringiensis strain EG-2348, Bacillus thuringiensis strain GC-91, Bacillus thuringiensis strain NCTC-11821, baculoviruses, Beauveria bassiana, Beauveria tenella, benclothiaz, bendiocarb, benfuracarb, bensultap, benzoximate, beta-cyfluthrin, beta-cypermethrin, bifenazate, bifenthrin, binapacryl, bioallethrin, bioallethrin-S-cyclopentyl isomer, bioethanomethrin, biopermethrin, bioresmethrin, bistrifluron, BPMC, brofenprox, bromophos-ethyl, bromopropylate, bromfenvinfos (-methyl), BTG-504, BTG-505, bufencarb, buprofezin, butathiofos, butocarboxim, butoxycarboxim, butylpyridaben, cadusafos, camphechlor, carbaryl, carbofuran, carbophenothion, carbosulfan, cartap, CGA-50439, chinomethionat, chlordane, chlordimeform, chloethocarb, chlorethoxyfos, chlorfenapyr, chlorfenvinphos, chlorfluazuron, chlormephos, chlorobenzilate, chloropicrin, chlorproxyfen, chlorpyrifos-methyl, chlorpyrifos (-ethyl), chlovaporthrin, chromafenozide, cis-cypermethrin, cis-resmethrin, cis-permethrin, clocythrin, cloethocarb, clofentezine, clothianidin, clothiazoben, codlemone, coumaphos, cyanofenphos, cyanophos, cycloprene, cycloprothrin, Cydia pomonella granuloviruses, cyfluthrin, cyhalothrin, cyhexatin, cypermethrin, cyphenothrin (1R-trans isomer), cyromazine, DDT, deltamethrin, demeton-S-methyl, demeton-S-methylsulfone, diafenthiuron, dialifos, diazinon, dichlofenthion, dichlorvos, dicofol, dicrotophos, dicyclanil, diflubenzuron, dimefluthrin, dimethoate, dimethylvinphos, dinobuton, dinocap, dinotefuran, diofenolan, disulfoton, docusat-sodium, dofenapyn, DOWCO-439, eflusilanate, emamectin, emamectin-benzoate, empenthrin (1R isomer), endosulfan, entomopthora spp., EPN, esfenvalerate, ethiofencarb, ethiprole, ethion, ethoprophos, etofenprox, etoxazole, etrimfos, famphur, fenamiphos, fenazaquin, fenbutatin oxide, fenfluthrin, fenitrothion, fenobucarb, fenothiocarb, fenoxacrim, fenoxycarb, fenpropathrin, fenpyrad, fenpyrithrin, fenpyroximate, fensulfothion, fenthion, fentrifanil, fenvalerate, fipronil, flonicamid, fluacrypyrim, fluazuron, flubenzimine, flubrocythrinate, flucycloxuron, flucythrinate, flufenerim, flufenoxuron, flufenprox, flumethrin, flupyrazofos, flutenzin (flufenzine), fluvalinate, fonofos, formetanate, formothion, fosmethilan, fosthiazate, fubfenprox (fluproxyfen), furathiocarb, gamma-cyhalothrin, gamma-HCH, gossyplure, grandlure, granuloviruses, halfenprox, halofenozide, HCH, HCN-801, heptenophos, hexaflumuron, hexythiazox, hydramethylnone, hydroprene, IKA-2002, imidacloprid, imiprothrin, indoxacarb, iodofenphos, iprobenfos, isazofos, isofenphos, isoprocarb, isoxathion, ivermectin, japonilure, kadethrin, nuclearpolyhedrosis viruses, kinoprene, lambda-cyhalothrin, lindane, lufenuron, malathion, mecarbam, mesulfenfos, metaldehyde, metam-sodium, methacrifos, methamidophos, Metharhizium anisopliae, Metharhizium flavoviride, methidathion, methiocarb, methomyl, methoprene, methoxychlor, methoxyfenozide, metofluthrin, metolcarb, metoxadiazone, mevinphos, milbemectin, milbemycin, MKI-245, MON-45700, monocrotophos, moxidectin, MTI-800, naled, NC-104, NC-170, NC-184, NC-194, NC-196, niclosamide, nicotine, nitenpyram, nithiazine, NNI-0001, NNI-0101, NNI-0250, NNI-9768, novaluron, noviflumuron, OK-5101, OK-5201, OK-9601, OK-9602, OK-9701, OK-9802, omethoate, oxamyl, oxydemeton-methyl, Paecilomyces fumosoroseus, parathion-methyl, parathion (-ethyl), permethrin (cis-, trans-), petroleum, PH-6045, phenothrin (1R trans isomer), phenthoate, phorate, phosalone, phosmet, phosphamidon, phosphocarb, phoxim, piperonyl butoxide, pirimicarb, pirimiphos-methyl, pirimiphos-ethyl, prallethrin, profenofos, profluthrin, promecarb, propaphos, propargite, propetamphos, propoxur, prothiofos, prothoate, protrifenbute, pymetrozine, pyraclofos, pyresmethrin, pyrethrum, pyridaben, pyridalyl, pyridaphenthion, pyridathion, pyrimidifen, pyriproxyfen, quinalphos, resmethrin, RH-5849, ribavirin, RU-12457, RU-15525, S-421, S-1833, salithion, sebufos, SI-0009, silafluofen, spinosad, spirodiclofen, spiromesifen, sulfluramid, sulfotep, sulprofos, SZI-121, tau-fluvalinate, tebufenozide, tebufenpyrad, tebupirimfos, teflubenzuron, tefluthrin, temephos, temivinphos, terbam, terbufos, tetrachlorvinphos, tetradifon, tetramethrin, tetramethrin (1R isomer), tetrasul, theta-cypermethrin, thiacloprid, thiamethoxam, thiapronil, thiatriphos, thiocyclam hydrogen oxalate, thiodicarb, thiofanox, thiometon, thiosultap-sodium, thuringiensin, tolfenpyrad, tralocythrin, tralomethrin, transfluthrin, triarathene, triazamate, triazophos, triazuron, trichlophenidine, trichlorfon, triflumuron, trimethacarb, vamidothion, vaniliprole, verbutin, Verticillium lecanii, WL-108477, WL-40027, YI-5201, YI-5301, YI-5302, XMC, xylylcarb, ZA-3274, zeta-cypermethrin, zolaprofos, ZXI-8901, the compound 3-methylphenyl propylcarbamate (tsumacide Z), the compound 3-(5-chloro-3-pyridinyl)-8-(2,2,2-trifluoroethyl)-8-azabicyclo[3.2.1]octane-3-carbonitrile (CAS Reg. No. 185982-80-3) and the corresponding 3-endo isomer (CAS Reg. No. 185984-60-5) (cf. WO-96/37494, WO-98/25923) and the compound of the formula (IIA)

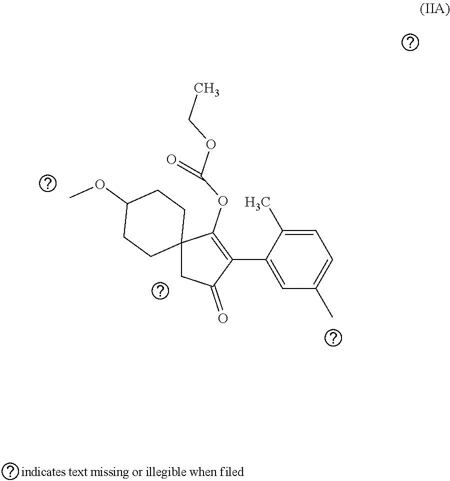

(carboxylic acid, 3-(2,5-dimethylphenyl)-8-methoxy-2-oxo-1-azaspiro[4.5]dec-3-en-4-yl ethyl ester, (9Cl)).

In an embodiment, the agrochemical suspension concentrate composition comprises an additional pesticidal active ingredient selected from aliphatic, nitrogen-containing fungicides: butylamine, cymoxanil, dodicin, dodine, guazatine, iminoctadine; amides: carpropamid, chloraniformethan, clozylacon, cyazofamid, cyflufenamid, diclocymet, ethaboxam, fenoxanil, flumetover, furametpyr, prochloraz, quinazamid, silthiofam, triforine, amino acids, such as, for example, benalaxyl, benalaxyl-M furalaxyl, metalaxyl, metalaxyl-M, pefurazoate, benzamides, such as, for example, benzohydroxamic acid, tioxymid, trichlamide, tricyclamide, zarilamid, zoxamide, furamides, such as, for example, cyclafuramid, furmecyclox, phenylsulfamides, such as, for example, dichlofluanid, tolylfluanid, valinamides, such as, for example, benthiavalicarb, iprovalicarb, anilides, such as, for example, benalaxyl, benalaxyl-M, boscalid, carboxin, fenhexamid, metalaxyl, metalaxyl-M, metsulfovax, ofurace, oxadixyl, oxycarboxin, pyracarbolid, thifluzamide, thiadinil, benzanilides, such as, for example, benodanil, flutolanil, mebenil, mepronil, salicylanilide, tecloftalam, furanilides, such as, for example, fenfuram, furalaxyl, furcarbanil, methfuroxam, sulfonanilides, such as, for example, flusulfamide; antibiotic fungicides: aureofungin, blasticidin-S, capsimycin, cycloheximide, griseofulvin, irumamycin, kasugamycin, mildiomycin, natamycin, polyoxins, polyoxorim, streptomycin, validamycin, strobins, such as, for example, azoxystrobin, dimoxystrobin, fluoxastrobin, kresoxim-methyl, metominostrobin, orysastrobin, picoxystrobin, pyraclostrobin, trifloxystrobin; aromatic fungicides: biphenyl, chloroneb, chlorothalonil, cresol, dicloran, hexachlorobenzene, pentachlorophenol, quintozene, sodium pentachlorophenoxide, tecnazene; benzimidazoles: benomyl, carbendazim, chlorfenazole, cypendazole, debacarb, fuberidazole, mecarbinzid, rabenzazole, thiabendazole; benzothiazoles: bentaluron, chlobenthiazone, TCMTB; diphenyl fungicides: bithionol, dichlorophen, diphenylamine; carbamates: benthiavalicarb, furophanate, iprovalicarb, propamocarb, thiophanate, thiophanate-methyl, benzimidazolylcarbamate, such as, for example, benomyl, carbendazim, cypendazole, debacarb, mecarbinzid, carbanilates, such as, for example, diethofencarb; conazoles: conazoles (imidazoles), such as, for example, climbazole, clotrimazole, imazalil, oxpoconazole, prochloraz, triflumizole, conazoles (triazoles), such as, for example, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P; copper fungicides: Bordeaux mixture, Burgundy mixture, Cheshunt mixture, copper acetate, copper carbonate (basic), copper hydroxide, copper naphthenate, copper oleate, copper oxychloride, copper sulfate, copper sulfate (basic), copper zinc chromate, cufraneb, cuprobam, cuprous oxide, mancopper, oxine copper; dicarboximides: famoxadone, fluoroimide, dichlorophenyldicarboximides, such as, for example, chlozolinate, dichlozoline, iprodione, isovaledione, myclozolin, procymidone, vinclozolin, phthalimides, such as, for example, captafol, captan, ditalimfos, folpet, thiochlorfenphim; dinitrophenols: binapacryl, dinobuton, dinocap, dinocap-4, dinocap-6, dinocton, dinopenton, dinosulfon, dinoterbon, DNOC; dithiocarbamates: azithiram, carbamorph, cufraneb, cuprobam, disulfiram, ferbam, metam, nabam, tecoram, thiram, ziram, cyclic dithiocarbamates, such as, for example, dazomet, etem, milneb, polymeric dithiocarbamates, such as, for example, mancopper, mancozeb, maneb, metiram, polycarbamate, propineb, zineb; imidazoles: cyazofamid, fenamidone, fenapanil, glyodin, iprodione, isovaledione, pefurazoate, triazoxide, morpholines: aldimorph, benzamorf, carbamorph, dimethomorph, dodemorph, fenpropimorph, flumorph, tridemorph; organophosphorus fungicides: ampropylfos, ditalimfos, edifenphos, fosetyl, hexylthiofos, iprobenfos, phosdiphen, pyrazophos, tolclofos-methyl, triamiphos; organotin compounds: decafentin, fentin, tributyltin oxide; oxathiines: carboxin, oxycarboxin, oxyfenthiin; oxazoles: chlozolinate, dichlozoline, drazoxolon, famoxadone, hymexazol, metazoxolon, myclozolin, oxadixyl, vinclozolin; pyridines: boscalid, buthiobate, dipyrithione, fluazinam, pyridinitril, pyrifenox, pyroxychlor, pyroxyfur; pyrimidines: andoprim, bupirimate, cyprodinil, diflumetorim, dimethirimol, ethirimol, fenarimol, ferimzone, meferimzone, mepanipyrim, nuarimol, pyrimethanil, triarimol; pyrroles: fenpiclonil, fludioxonil, fluoroimide, pyrrolnitrine; quinolines: ethoxyquin, halacrinate, 8-hydroxyquinoline sulfate, quinacetol, quinoxyfen; quinones: benquinox, chloranil, dichlone, dithianon; quinoxalines: chinomethionat, chlorquinox, thioquinox; thiazoles: ethaboxam, etridiazole, metsulfovax, octhilinone, thiabendazole, thiadifluor, thifluzamide; thiocarbamates: methasulfocarb, prothiocarb; thiophenes: ethaboxam, silthiofam; triazines: anilazine; triazoles: bitertanol, fluotrimazole, triazbutil (see also conazoles (triazoles)); ureas: bentaluron, pencycuron, quinazamid; non-classified fungicides: acibenzolar, acypetacs, allyl alcohol, benzalkonium chloride, benzamacril, bethoxazin, carvone, chloropicrin, cyprofuram, DBCP, dehydroacetic acid, diclomezine, diethylpyrocarbonate, fenaminosulf, fenitropan, fenpropidin, formaldehyde, hexachlorobutadiene, isoprothiolane, methylbromid, methyl isothiocyanate, metrafenone, nicobifen, nitrostyrene, nitrothal-isopropyl, OCH, oxolinix acid, 2-phenylphenol, phthalide, piperalin, probenazole, proquinazid, pyroquilon, sodium orthophenylphenoxide, spiroxamine, sultropen, thicyofen, tricyclazole, zinc naphthenate, (2S)—N-[2-[4-[[3-(4-chlorophenyl)-2-propynyl]oxy]-3-methoxyphenyl]ethyl]-3-methyl-2-[(methylsulfonyl)amino]-butanamide; 1-(1-naphthalenyl)-1H-pyrrole-2,5-dione; 2,3,5,6-tetrachloro-4-(methylsulfonyl)-pyridine; 2-amino-4-methyl-N-phenyl-5-thiazolecarboxamide; 2-chloro-N-(2,3-dihydro-1,1,3-trimethyl-1H-inden-4-yl)-3-pyridincarboxamide; 3,4,5-trichloro-2,6-pyridinedicarbonitrile; cis-1-(4-chlorophenyl)-2-(1H-1,2,4-triazole-1-yl)-cycloheptanol; methyl 1-(2,3-dihydro-2,2-dimethyl-1H-inden-1-yl)-1H-imidazole-5-carboxylate; monopotassium carbonate; N-(6-methoxy-3-pyridinyl)-cyclopropanecarboxamide; N-butyl-8-(1,1-dimethylethyl)-1-oxaspiro[4.5]decan-3-amine.

In an embodiment, the agrochemical suspension concentrate composition comprises an additional pesticidal active ingredient selected from abamectin, acetamiprid, acequinocyl, acynonapyr, afidopyropen, amitraz, avermectins, azadirachtin, benzpyrimoxan, bifenazate, bifenthrin, broflanilide, buprofezin, cartap, chlorfenapyr, chlorpyrifos, clothianidin, cyfluthrin, beta-cyfluthrin, sila-cyflumetofen, cyclaniliprole, cycloxaprid, cyenopyrafen, cyflumetofen, cyhalothrin, lambda-cyhalothrin, cypermethrin, cyproflanilide, cyromazine, deltamethrin, dicloromezotiaz, dieldrin, dimpropyridaz, dinotefuran, diofenolan, emamectin, endosulfan, esfenvalerate, ethiprole, fenazaquin, fenothiocarb, fenoxycarb, fenvalerate, fenpyroximate, fipronil, fionicamid, flometoquin, flufenoxuron, flufiprole, fluhexafon, flupyradifurone, flupyrimin, fluxametamide, gamma-cyhalothrin, hexaflumuron, hydramethyhion, imidacloprid, indoxacarb, isocycloseram, lufenuron, metaflumizone, methomyl, methoprene, methoxyfenozide, nicofluprole, nitenpyram, nithiazine, novaluron, oxamyl, oxazosulfyl, propargite, pyflubumide, pymetrozine, pyrethrin, pyridaben, pyridalyl, pyrifluquinazon, pyriproxyfen, spidoxomat, spinetoram, spinosad, spirodiclofen, spiromesifen, spiropidion, spirotetramate, tebufenozide, tetraniliprole, tebufenpyrad, thiacloprid, thiamethoxam, thiodicarb, thiotraniliprole, thiosultap-sodium, tolfenpyrad, tralomethrin, triazamate, triflumezopyrim, triflumuron, tyclopyrazoflor.

In an embodiment, the agrochemical suspension concentrate composition comprises an additional pesticidal active ingredient selected from chlorfenapyr, spirotetramate, acetamiprid, novaluron, flupyrimin, methoxyfenozide.

In an embodiment, the amount of an additional pesticidal active ingredient is from 0.5% to 20% per weight of total composition.

In another embodiment, the amount of an additional pesticidal active ingredient is from 10% to 20% per weight of total composition.

In another embodiment, the amount of an additional pesticidal active ingredient is from 5.0% to 10% per weight of total composition.

In another embodiment, the amount of an additional pesticidal active ingredient is from 1.0 to 5.0% per weight of total composition.

In another embodiment, the amount of an additional pesticidal active ingredient is from 0.5 to 1.0% per weight of total composition.

In an embodiment, the amount of an additional pesticidal active ingredient is from 1.0 to 5.0% per weight of total composition.

In another embodiment, the ratio between diamide insecticide and an additional pesticidal active ingredient is from 120:1 to 2:1.

In another embodiment, the ratio between diamide insecticide and an additional pesticidal active ingredient is from 100:1 to 5:1.

In another embodiment, the ratio between diamide insecticide and an additional pesticidal active ingredient is from 100:1 to 10:1.

In another embodiment, the ratio between diamide insecticide and an additional pesticidal active ingredient is from 50:1 to 2:1.

In another embodiment, the ratio between diamide insecticide and an additional pesticidal active ingredient is from 20:1 to 2:1.

In another embodiment, the ratio between diamide insecticide and an additional pesticidal active ingredient is from 10:1 to 2:1.

In an embodiment, the agrochemical suspension concentrate composition comprises chlorantraniliprole and chlorfenapyr.

In an embodiment, the agrochemical suspension concentrate composition comprises chlorantraniliprole and flupyrimin.

In an embodiment, the agrochemical suspension concentrate composition comprises chlorantraniliprole and spirotetramate.

In an embodiment, the agrochemical suspension concentrate composition comprises chlorantraniliprole and novaluron.

In an embodiment, the agrochemical suspension concentrate composition comprises chlorantraniliprole and methoxyfenozide.

In an embodiment, the agrochemical suspension concentrate composition comprises cyantraniliprole and chlorfenapyr.

In an embodiment, the agrochemical suspension concentrate composition comprises cyantraniliprole and acetamiprid.

In an embodiment, the agrochemical suspension concentrate composition comprises cyantraniliprole and spirotetramate.

In an embodiment, the agrochemical suspension concentrate composition comprises cyantraniliprole and flupyrimin.

In an embodiment, the agrochemical suspension concentrate composition comprises cyantraniliprole and methoxyfenozide.

In an embodiment, the agrochemical suspension concentrate composition comprises cyantraniliprole and novaluron.

### Methods of Preparation and Applying of Agrochemical Composition:

Methods for making agrochemical suspension concentrate compositions are well known in the art and include ball-milling, bead-milling, sand-milling, colloid milling and air-milling combined with high-speed blending. The listed methods can be used in the preparation of the compositions of the present invention. This invention also relates to a method for controlling a pest comprising diluting said suspension composition with water and contacting the pest or its environment with an effective amount of said diluted composition. The preferred method for applying the diluted compositions of the present invention, such as spraying, atomizing, dispersing or pouring, will depend on the desired objectives and the given circumstances, and can be readily determined by one skilled in the art.

The pH of the suspension concentrate agrochemical composition may range from 3.5 to 7, from 4 to 6.5, or from 4.5 to 6.0.

The distribution of the particle size for the agrochemical suspension concentrate composition may show a D (90) less than 15 μm, preferably from about 1 μm to 14 μm, more preferably from about 3 μm to 13 μm, and most preferably from 3 μm to 10 μm.

The viscosity of the suspension concentrate agrochemical composition may range from 30 to 5,000 centipoise (cps), from 50 to 4,000 cps, or from 100 to 3,200 cps, when it is measured with a Brookfield DV2T viscosimeter using spindle 63 or spindle 62 at 12 rpm at room temperature.

In certain embodiments, agrochemical suspension concentrate composition of the invention, as defined according to any one of the embodiments above used for a method for controlling an arthropod pest, comprising diluting a suspension concentrate composition with water, and optionally adding an adjuvant to form a diluted composition, and contacting the arthropod pest or its environment with an effective amount of said diluted composition.

Adjuvants are auxiliaries, which are added to agricultural compositions so as to increase the effectiveness of one or more of the pesticidal active agents comprised therein, e.g., a diamides and additional pesticidal active ingredients (preferably, insecticides). The increase in the efficacy of said agrochemical agent induced by the presence of said adjuvant may be due to several possible modes of action such as facilitated wetting, penetration, or better retention.

In an embodiment the adjuvant is selected from Tween 20, SK oil, Synergen GA, Tween 22, Tween 23, Tween 24, Synergen GL5, Agnique PG 8107-BL, Atplus UEP 100 and the like.

In a particular aspect, the present invention discloses a method of controlling pest comprising applying to a locus where control of said pest is desired an effective amount of the suspension concentrate composition as defined in any one of the embodiments above.

In some embodiments, a pest is a plant pest. In some embodiments, said pest is referred to an insect pest selected from Lepidoptera, Coleoptera, Isoptera, Hemiptera, Orthoptera, Thysanoptera and Diptera species.

In an embodiment, the target pest belongs to Acarina pest (e.g. mites).

In particular, Coleoptera, such as Acanthoscelides spp. (weevils), Acanthoscelides obtectus (common bean weevil), Agrilus planipennis (emerald ash borer), Agriotes spp. (wireworms), Anoplophora glabripennis (Asian longhorned beetle), Anthonomus spp. (weevils), Anthonomus grandis (boll weevil), Aphidius spp., Apion spp. (weevils), Apogonia spp. (grubs), Ataenius spretulus (Black Turgrass Ataenius), Atomaria linearis (pygmy mangold beetle), Aulacophore spp., Bothynoderes punctiventris (beet root weevil), Bruchus spp. (weevils), Bruchus pisorum (pea weevil), Cacoesia spp., Callosobruchus maculatus (southern cow pea weevil), Carpophilus hemipteras (dried fruit beetle), Cassida vittata, Cerosterna spp, Cerotoma spp. (chrysomeids), Cerotoma trifurcata (bean leaf beetle), Ceutorhynchus spp. (weevils), Ceutorhynchus assimilis (cabbage seedpod weevil), Ceutorhynchus napi (cabbage curculio), Chaetocnema spp. (chrysomelids), Colaspis spp. (soil beetles), Conoderus scalaris, Conoderus stigmosus, Conotrachelus nenuphar (plum curculio), Cotinus nitidis (Green June beetle), Crioceris asparagi (asparagus beetle), Cryptolestes ferrugineus (rusty grain beetle), Cryptolestes pusillus (flat grain beetle), Cryptolestes turcicus (Turkish grain beetle), Ctenicera spp. (wireworms), Curculio spp. (weevils), Cyclocephala spp. (grubs), Cylindrocpturus adspersus (sunflower stem weevil), Deporaus marginatus (mango leaf-cutting weevil), Dermestes lardarius (larder beetle), Dermestes maculates (hide beetle), Diabrotica spp. (chrysolemids), Epilachna varivestis (Mexican bean beetle), Faustinus cubae, Hylobius pales (pales weevil), Hypera spp. (weevils), Hypera postica (alfalfa weevil), Hyperdoes spp. (Hyperodes weevil), Hypothenemus hampei (coffee berry beetle), Ips spp. (engravers), Lasioderma serricorne (cigarette beetle), Leptinotarsa decemlineata (Colorado potato beetle), Liogenys futscus, Liogenys suturalis, Lissorhoptrus oryzophilus (rice water weevil), Lyctus spp. (wood beetles/powder post beetles), Maecolaspis joliveti, Megascelis spp., Melanotus communis, Meligethes spp., Meligethes aeneus (blossom beetle), Melolontha (common European cockchafer), Oberea brevis, Oberea linearis, Oryctes rhinoceros (date palm beetle), Oryzaephilus mercator (merchant grain beetle), Oryzaephilus surinamensis (sawtoothed grain beetle), Otiorhynchus spp. (weevils), Oulema melanopus (cereal leaf beetle), Oulema oryzae, Pantomorus spp. (weevils), Phyllophaga spp. (May/June beetle), Phyllophaga cuyabana, Phyllotreta spp. (chrysomelids), Phynchites spp., Popillia japonica (Japanese beetle), Prostephanus truncates (larger grain borer), Rhizopertha dominica (lesser grain borer), Rhizotrogus spp. (Eurpoean chafer), Rhynchophorus spp. (weevils), Scolytus spp. (wood beetles), Shenophorus spp. (Billbug), Sitona lineatus (pea leaf weevil), Sitophilus spp. (grain weevils), Sitophilus granaries (granary weevil), Sitophilus oryzae (rice weevil), Stegobium paniceum (drugstore beetle), Tribolium spp. (flour beetles), Tribolium castaneum (red flour beetle), Tribolium confusum (confused flour beetle), Trogoderma variabile (warehouse beetle) and Zabrus tenebioides.

Diptera, such as Aedes spp. (mosquitoes), Agromyza frontella (alfalfa blotch leafminer), Agromyza spp. (leaf miner flies), Anastrepha spp. (fruit flies), Anastrepha suspensa (Caribbean fruit fly), Anopheles spp. (mosquitoes), Batrocera spp. (fruit flies), Bactrocera cucurbitae (melon fly), Bactrocera dorsalis (oriental fruit fly), Ceratitis spp. (fruit flies), Ceratitis capitata (Mediterranea fruit fly), Chrysops spp. (deer flies), Cocliliomyia spp. (screwworms), Contarinia spp. (Gall midges), Culex spp. (mosquitoes), Dasineura spp. (gall midges), Dasineura brassicae (cabbage gall midge), Delia spp., Delia platura (seedcorn maggot), Drosophila spp. (vinegar flies), Fannia spp. (filth flies), Fannia canicularis (little house fly), Fannia scalaris (latrine fly), Gasterophilus intestinalis (horse bot fly), Gracillia perseae, Haematobia irritans (horn fly), Hylemyia spp. (root maggots), Hypoderma lineatum (common cattle grub), Liriomyza spp. (leafminer flies), Liriomyza brassica (serpentine leafminer), Melophagus ovinus (sheep ked), Musca spp. (muscid flies), Musca autumnalis (face fly), Musca domestica (house fly), Oestrus ovis (sheep bot fly), Oscinella frit (grass fly), Pegomyia betae (beet leafminer), Phorbia spp., Psila rosae (carrot rust fly), Rhagoletis cerasi (cherry fruit fly), Rhagoletis pomonella (apple maggot), Sitodiplosis mosellana (orange wheat blossom midge), Stomoxys calcitrans (stable fly), Tabanus spp. (horse flies) and Tipula spp. (crane flies).

Hemiptera, such as Acrosternum hilare (green stink bug), Blissus leucopterus (chinch bug), Calocoris norvegicus (potato mirid), Cimex hemipterus (tropical bed bug), Cimex lectularius (bed bug), Dagbertus fasciatus, Dichelops furcatus, Dysdercus suturellus (cotton stainer), Edessa meditabunda, Eurygaster maura (cereal bug), Euschistus heros, Euschistus servus (brown stink bug), Helopeltis antonii, Helopeltis theivora (tea blight plantbug), Lagynotomus spp. (stink bugs), Leptocorisa oratorius, Leptocorisa varicornis, Lygus spp. (plant bugs), Lygus hesperus (western tarnished plant bug), Maconellicoccus hirsutus, Neurocolpus longirostris, Nezara viridula (southern green stink bug), Paratrioza cockerelli, Phytocoris spp. (plant bugs), Phytocoris californicus, Phytocoris relativus, Piezodorus guildingi, Poecilocapsus lineatus (fourlined plant bug), Psallus vaccinicola, Pseudacysta perseae, Scaptocoris castanea and Triatoma spp. (bloodsucking conenose bugs/kissing bugs).

Homoptera, such as Acrythosiphon pisum (pea aphid), Adelges spp. (adelgids), Aleurodes proletella (cabbage whitefly), Aleurodicus disperses, Aleurothrixus floccosus (woolly whitefly), Aluacaspis spp., Amrasca bigutella, Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale) and Zulia entreriana.

Lepidoptera, such as Achoea janata, Adoxophyes spp., Adoxophyes orana, Agrotis spp. (cutworms), Agrotis ipsilon (black cutworm), Alabama argillacea (cotton leafworm), Amorbia cuneana, Amyelosis transitella (navel orangeworm), Anacamptodes defectaria, Anarsia lineatella (peach twig borer), Anomis sabulifera (jute looper), Anticarsia gemmatalis (velvetbean caterpillar), Archips argyrospila (fruittree leafroller), Archips rosana (rose leaf roller), Argyrotaenia spp. (tortricid moths), Argyrotaenia citrana (orange tortrix), Autographa gamma, Bonagota cranaodes, Borbo cinnara (rice leaf folder), Bucculatrix thurberiella (cotton leafperforator), Caloptilia spp. (leaf miners), Capua reticulana, Carposina niponensis (peach fruit moth), Chilo spp., Chlumetia transversa (mango shoot borer), Choristoneura rosaceana (obliquebanded leafroller), Chrysodeixis spp., Cnaphalocerus medinalis (grass leafroller), Colias spp., Conpomorpha cramerella, Cossus (carpenter moth), Crambus spp. (Sod webworms), Cydia funebrana (plum fruit moth), Cydia molesta (oriental fruit moth), Cydia nignicana (pea moth), Cydia pomonella (codling moth), Darna diducta, Diaphania spp. (stem borers), Diatraea spp. (stalk borers), Diatraea saccharalis (sugarcane borer), Diatraea graniosella (southwester corn borer), Earias spp. (bollworms), Earias insulata (Egyptian bollworm), Earias vitella (rough northern bollworm), Ecdytopopha aurantianum, Elasmopalpus lignosellus (lesser cornstalk borer), Epiphysias postruttana (light brown apple moth), Ephestia spp. (flour moths), Ephestia cautella (almond moth), Ephestia elutella (tobbaco moth), Ephestia kuehniella (Mediterranean flour moth), Epimeces spp., Epinotia aporema, Erionota thrax (banana skipper), Eupoecilia ambiguella (grape berry moth), Euxoa auxiliaris (army cutworm), Feltia spp. (cutworms), Gortyna spp. (stemborers), Grapholita molesta (oriental fruit moth), Hedylepta indicata (bean leaf webber), Helicoverpa spp. (noctuid moths), Helicoverpa armigera (cotton bollworm), Helicoverpa zea (bollworm/corn earworm), Heliothis spp. (noctuid moths), Heliothis virescens (tobacco budworm), Hellula undalis (cabbage webworm), Indarbela spp. (root borers), Keiferia lycopersicella (tomato pinworm), Leucinodes orbonalis (eggplant fruit borer), Leucoptera malifoliella, Lithocollectis spp., Lobesia botrana (grape fruit moth), Loxagrotis spp. (noctuid moths), Loxagrotis albicosta (western bean cutworm), Lymantria dispar (gypsy moth), Lyonetia clerkella (apple leaf miner), Mahasena corbetti (oil palm bagworm), Malacosoma spp. (tent caterpillars), Mamestra brassicae (cabbage armyworm), Maruca testulalis (bean pod borer), Metisa plana (bagworm), Mythimna unipuncta (true armyworm), Neoleucinodes elegantalis (small tomato borer), Nymphula depunctalis (rice caseworm), Operophthera brumata (winter moth), Ostrinia nubilalis (European corn borer), Oxydia vesulia, Pandemis cerasana (common currant tortrix), Pandemis heparana (brown apple tortrix), Papilio demodocus, Pectinophora gossypiella (pink bollworm), Peridroma spp. (cutworms), Peridroma saucia (variegated cutworm), Perileucoptera coffeella (white coffee leafminer), Phthorimaea operculella (potato tuber moth), Phyllocnisitis citrella, Phyllonorycter spp. (leafminers), Pieris rapae (imported cabbageworm), Plathypena scabra, Plodia interpunctella (Indian meal moth), Plutella xylostella (diamondback moth), Polychrosis viteana (grape berry moth), Prays endocarpa, Prays oleae (olive moth), Pseudaletia spp. (noctuid moths), Pseudaletia unipunctata (armyworm), Pseudoplusia includens (soybean looper), Rachiplusia nu, Scirpophaga incertulas, Sesamia spp. (stemborers), Sesamia inferens (pink rice stem borer), Sesamia nonagrioides, Setora nitens, Sitotroga cerealella (Angoumois grain moth), Sparganothis pilleriana, Spodoptera spp. (armyworms), Spodoptera exigua (beet armyworm), Spodoptera fugiperda (fall armyworm), Spodoptera oridania (southern armyworm), Synanthedon spp. (root borers), Thecla basilides, Thermisia gemmatalis, Tineola bisselliella (webbing clothes moth), Trichoplusia ni (cabbage looper), Tuta absoluta, Yponomeuta spp., Zeuzera coffeae (red branch borer) and Zeuzera pyrina (leopard moth).

Orthoptera, such as Anabrus simplex (Mormon cricket), Gryllotalpidae (mole crickets), Locusta migratoria, Melanoplus spp. (grasshoppers), Microcentrum retinerve (angularwinged katydid), Pterophylla spp. (kaydids), Chistocerca gregaria, Scudderia furcata (forktailed bush katydid) and Valanga nigricorni.

Thysanoptera, such as Frankliniella fusca (tobacco thrips), Frankliniella occidentalis (western flower thrips), Frankliniella shultzei Frankliniella williamsi (corn thrips), Heliothrips haemorrhaidalis (greenhouse thrips), Riphiphorothrips cruentatus, Scirtothrips spp., Scirtothrips citri (citrus thrips), Scirtothrips dorsalis (yellow tea thrips), Taeniothrips rhopalantennalis and Thrips spp.

Acarina, such as Acarus siro, Aceria spp., Aculus schlechtendali, Amblyomma spp., Argas spp., Boophilus spp., Brevipalpus spp., Bryobia praetiosa, Calipitrimerus spp., Chorioptes spp., Dermanyssus gallinae, Eotetranychus spp., Eurytetranychus spp., Eriophyes spp., Hyalomma spp., Ixodes spp., Nalepella spp., Olygonychus spp., Ornithodoros spp., Panonychus spp., Phyllocoptruta oleivora, Phytonemus spp., Polyphagotarsonemus latus, Psoroptes spp., Rhipicephalus spp., Rhizoglyphus spp., Sarcoptes spp., Tarsonemus spp., Tetranychus spp, and Vasates spp.

In another particular aspect, the present invention discloses a method for the protection of plant propagation material from the attack by a pest such as an insect and/or mite, comprising treating the propagation material or the site where the propagation material is to be planted with an effective amount of suspension concentrate composition as defined herein.

The term “locus” as used herein refers not only to areas where the pest such as an insect and/or mite may already be developed, but also to areas that have not yet been attacked by said pest, and to areas under cultivation. Locus includes the crop and propagation material of the crop (all the generative parts of the crop such as seeds and vegetative plant material such as cuttings and tubers, which can be used for the multiplication of the plant. Examples of propagation material of the crop include seeds, tubers, spores, corms, bulbs, rhizomes, sprouts basal shoots, stolons, buds and other parts of plants, including seedlings and young plants, which could be transplanted after germination or after emergence from soil. Locus also includes the area surrounding the crop and the growing media of the crop, such as soil and crop field.

In certain embodiments, the locus treated by the method disclosed herein above is a field of crop. The term “crop” (or “plant”) as used herein refers to whole plants, plant organs (e.g., leaves, stems, twigs, roots, trunks, limbs, shoots, fruits, etc.), plant cells, or plant seeds. Non-limiting examples of crops are oilseed rape (e.g. canola), cotton, rice, banana, potato (including sweet potato), coffee, sugar cane, citrus, beans, sunflower, corn, soybean, wheat, barley, oats, chickpeas, fruit trees, nut trees (e.g. almonds), lentils, grain sorghum, alfalfa, brassicas, fruiting vegetables (e.g. tomatoes, pepper, chili, eggplant, cucumber, squash etc.), tea, bulb vegetables (e.g. onion, leek etc.), grapes, pome fruit (e.g. apples, pears etc.), and stone fruit (e.g. pears, plums etc.)

The present invention will now be illustrated by the following non-limiting Examples.

### EXPERIMENTAL PART

### Example 1. General Procedure of Preparation of Suspension Concentrate Containing Diamide

1. Nonionic stabilizer/s (e.g Tergitol™ 15-s-7 (DOW), Antarox® B/848 (Solvay), Atlox™ 4913 (Croda), Silwet™ L-77 (Momentive), propylene glycol and anti-foam emulsion added to soft water and the mixture was stirred until homogenous suspension is obtained.
2. Anionic stabilizer/s added (polyelectrolyte block copolymer, Morwet® D-809 (Nouryon), Lankropol® KO2 (Nouryon)) and the obtained mixture stirred until homogenous suspension formed.
3. Diamide tech. powder (e.g. chlorantraniliprole or cyantraniliprole) added to the previously prepared mixture with high shearing until homogenous dispersion is obtained.
4. Optionally, additional active ingredient (e.g. chlorfenapyr, novaluron,) tech. powder added to the previously prepared mixture with high shearing until homogenous dispersion is obtained.
5. The homogenous dispersion as previously prepared milled until particle size range d90<10 μm obtained.
6. Proxel™ GXL (Lonza), Xanthan Gum solution AG RH 23 (2% w/w) (Azelis) and the remaining soft water added, and the final composition was mixed until homogenous dispersion is obtained.

COMPARATIVE EXAMPLE 2: The series of compositions with increasing amounts of Cyantraniliprole, based on similar composition matrix were prepared according to the procedure of EXAMPLE 1 and represented below in Table 1. All values in the Table 1 represented as weight percentages per weight of total composition. The preparation tests showed that a maximal amount of cyantraniliprole that can be formulated as suspension concentrate is 40% by weight of cyantraniliprole. At higher amounts of cyantraniliprole, (for example 49.38% by weight) the slurry is too viscous and cannot be milled for further processing to afford suspension concentrate composition.

TABLE 1
Compositions A-D

| | Composi- | Composi- | Composi- | Composi- |
|---|---|---|---|---|
| Chemical name | tion A | tion B | tion C | tion D |
| Cyantraniliprole | 18.07% | 26.84% | 35.48% | 49.38% |
| Tech | | | | |
| Lankropol KO2 | 1.00% | 1.00% | 1.00% | 1.00% |
| Tergitol 15-s- 7 | 1.00% | 2.00% | 1.00% | 2.00% |
| Morwet D-809 | 3.00% | 3.00% | 3.00% | 3.00% |
| Antharox B/848 | 2.00% | 2.00% | 2.00% | 2.00% |
| Propylene | 5.00% | 8.00% | 8.00% | 8.00% |
| glycol | | | | |
| Silcolapse 432 | 0.11% | 1.00% | 1.00% | 0.35% |
| VanGel B | 0.50% | 0.50% | 0.45% | 0.50% |
| Silwet L-77 | 3.20% | | | |
| Proxel GXL | 0.13% | 0.10% | 0.10% | 0.10% |
| Xanthan gum | 0.03% | 0.26% | 0.20% | 0.04% |
| water | 65.95% | 55.29% | 47.77% | 36.63% |

TABLE 2
Physical stability tests for compositions A, B, C, D

| | | Composition A | Composition B | Composition C | Composition D |
|---|---|---|---|---|---|
| | | (Cyantraniliprole | (Cyantraniliprole | (Cyantraniliprole | (Cyantraniliprole |
| | Test | 18.1%) | 26.8%) | 35.5%) | 49.4%) |
| Room | Phase separation | 0 | 0 | 0 | Impossible to mill, |
| | Viscosity | 1500 | 1230 | 2050 | viscous sticky mass |
| | (12 rpm, S-63) | | | | formed and cannot |
| | Particle's size (μ) | 3.00 | 2.11 | 2.96 | be processes |
| Oven | Phase separation | 0 | 0 | 0 | |
| 54 °C | Viscosity | 1400 | 1300 | 1780 | |
| | (12 rpm, S-63) | | | | |
| | Particle's size (μ) | 3.10 | 2.00 | 3.00 | |

### Comparative Example 3

The composition D represented below in Table 3 was prepared according to the method of EXAMPLE 1.

TABLE 3
Composition D

| | Composition D |
|---|---|
| | (Cyantraniliprole |
| Chemical name | 49.4% w/w) |
| Cyantraniliprole | 49.38% |
| Tech | |
| Lankropol KO2 | 1.50% |
| Tergitol 15 s 7 | 2.00% |
| Morwet D-809 | 4.00% |
| Antharox B/848 | 2.00% |
| Propylene | 4.00% |
| glycol | |
| Silcolapse 432 | 0.35% |
| VanGel B | 0.50% |
| Proxel GXL | 0.10% |
| Xanthan gum | 0.04% |
| water | 36.13 |

The increased amounts of wetting agents (Lankropol KO2 and/or Tergitol 15-s-7) and dispersants (Morwet D-809) in composition D as compared to composition C above, still resulted in high viscosity and poor wettability of the premix during the process of milling.

### Comparative Example 4

The composition E represented below in Table 4 was prepared according to general method of EXAMPLE 1.

TABLE 4
Composition E

| | Composition E |
|---|---|
| | (Cyantraniliprole |
| Chemical name | 51.05%) |
| Cyantraniliprole Tech | 51.05% |
| Aerosol OT-B | 2.00% |
| PolyAgro A | 3.13% |
| Atlox 4913 | 3.57% |
| Tergitol 15-S-7 | 0.45% |
| SAG 1538 | 0.55% |
| Morwet D- | 5.00% |
| 809 Powder | |
| Propylene glycol | 4.00% |
| Van Gel B | 0.50% |
| water | 30.5% |

Composition E above containing polyelectrolyte block copolymer PolyAgro A as additional stabilizing excipient, solidified at temperature of 54 °C after 2 weeks under common long term storage stability test conditions. Discarding of the non-ionic wetting agent Tergitol 15-s-7, led to stable composition F, which showed good physical stability test as shown below in Table 5.

TABLE 5
Composition F.

| | Composition F |
|---|---|
| | (Cyantraniliprole |
| Chemical name | 49.38% w/w) |
| Cyantraniliprole Tech | 49.38% |
| Aerosol OT-B | 2.00% |
| PolyAgro A | 4.50% |
| Atlox 4913 | 4.50% |
| SAG 1538 | 0.50% |
| Morwet D- | 6.00% |
| 809 Powder | |
| Propylene glycol | 4.00% |
| Rhodosil 432 | 0.25% |
| Proxel GXL | 0.01% |
| Xanthan gum | 0.10% |
| water | 28.76% |

TABLE 6
Physical stability test of Composition F.

| Test | Room after 2 weeks | Oven 54 °C |
|---|---|---|
| Viscosity (12 rpm, S-63) | 2680 | 1570 |
| Particle size distribution | 2.7 | 2.6 |
| (D90, μm) | | |

However, Composition F didn't show a blooming effect. “Blooming effect” or “spontaneity of dispersion” is checked by pouring a few ml of the tested suspension concentrate composition with a pipette into a test tube containing 250 ml of standard hardness water (water “D” in CIPAC) at room temperature. By inverting the test-tube the formulation should disperse.
after the entrance to water.

Composition F requires intensive agitation to be dispersed in water and does not form spontaneous homogeneous dispersion in water upon dilution.

EXAMPLE 5. Organosilicon wetting agent was added to composition F to obtain the stable inventive Composition G showing good physical stability and appropriate blooming after entrance to water as shown below in Table 7.

TABLE 7
Composition G.

| | Composition G |
|---|---|
| | ( Cyantraniliprole |
| Chemical name | 49.38% w/w) |
| Cyantraniliprole Tech | 49.38% |
| Morwet D-809 | 6.00% |
| Propylene glycol | 4.00% |
| Aerosol OT-B | 1.50% |
| Silwet L-77 | 0.50% |
| PolyAgro A | 4.50% |
| Atlox 4913 | 4.50% |
| SAG 1538 | 0.50% |
| Rhodosil 432 | 0.50% |
| Proxel GXL | 0.01% |
| Xanthan gum | 0.10% |
| water | 28.51% |

Composition G shows good physical stability tests as summarized in TABLE 8 below.

TABLE 8
Physical stability test of Composition G.

| Test | Room after 2 weeks | Oven 54 °C |
|---|---|---|
| Viscosity (12 rpm, S-63) | 1290 | 920 |
| Particle's size (μ) | 4.37 | 4.05 |

EXAMPLE 6. Composition H prepared according to the method of EXAMPLE 1 and shown in Table 9, has good physical stability and appropriate blooming effect as showed below.

TABLE 9
Composition H

| | Composition H |
|---|---|
| | (Chlorantraniliprole |
| Chemical name | 49.79% w/w) |
| Chlorantraniliprole Tech | 49.79% |
| Morwet D-809 | 6.00% |
| Propylene glycol | 4.50% |
| Aerosol OT-B | 1.50% |
| Silwet L-77 | 0.50% |
| PolyAgro A | 4.50% |
| Atlox 4913 | 4.50% |
| SAG 1538 | 0.50% |
| Rhodosil 432 | 0.50% |
| Proxel GXL | 0.01% |
| Xanthan gum | 0.60% |
| water | 27.10% |

TABLE 10
Physical stability test for Composition H.

| Test | Room | Oven 54 °C |
|---|---|---|
| Viscosity (12 rpm, S-63) | 800 | 1250 |
| Particle's size (μ) | 1.37 | 1.41 |

1. An agrochemical suspension concentrate composition comprising:
a) more than 40% of diamide per weight of total composition
b) silicone surfactant
c) polyelectrolyte block copolymer
d) sulfonate surfactant
e) water.

2. An agrochemical suspension concentrate composition according to claim 1, comprising:
a) more than 40% of diamide per weight of total composition
b) 0.1 to 5.0% of silicone surfactant
c) 1.0 to 10% of polyelectrolyte block copolymer
d) 1.0 to 10% of sulfonate surfactant
e) water.

3. An agrochemical suspension concentrate composition according to claims 1-2, comprising a) from 41% to 60% of diamide per weight of total composition.

4. An agrochemical suspension concentrate composition according to claims 1-3, wherein the diamide is selected from chlorantraniliprole, cyantraniliprole, bromantraniliprole, tetrantraniliprole and the mixtures thereof.

5. An agrochemical suspension concentrate composition according to claims 1-4, wherein the ratio of silicone surfactant b) to polyelectrolyte block copolymer c) is from about 1:15 to 15:1.

6. An agrochemical suspension concentrate composition according to claims 1-4, wherein the ratio of polyelectrolyte block copolymer c) sulfonate surfactant d) is from about 1:55 to 5:1.

7. An agrochemical suspension concentrate composition according to claims 1-4, wherein the silicone surfactant a) is selected from trisiloxane polyalkyleneoxides, organomodified trisiloxane polyalkyleneoxides and the mixtures thereof.

8. An agrochemical suspension concentrate composition according to claims 1-4, wherein the polyelectrolyte block copolymer c) comprises (A) an anchoring moiety and (B) at least one stabilizing moiety.

9. An agrochemical suspension concentrate composition according to claims 1-4, wherein the polyelectrolyte block copolymer c) comprises at least 90% of the anchoring moiety (A) consisting of acrylate derivatives, methacrylate derivatives, styrene derivatives, and any combination thereof.

10. An agrochemical suspension concentrate composition according to claims 1-4, wherein the polyelectrolyte block copolymer c) comprises hydrophilic block copolymer as stabilizing moiety (B).

11. An agrochemical suspension concentrate composition according to claims 1-4, wherein the polyelectrolyte block copolymer c) comprises a stabilizing moiety (B) containing of at least 60% by weight of charged anionic monomers.

12. An agrochemical suspension concentrate composition according to claims 1-4, wherein the polyelectrolyte block copolymer c) comprising 77% of sodium 2-acryloylamino-2-methylpropane-I-sulfonate (AMPS) monomers and 23% of the ethyl acrylate (EA) monomers.

13. An agrochemical suspension concentrate composition according to claims 1-4, wherein the sulfonate surfactant d) is selected from aryl sulfonates, alkyl aryl sulfonates, lignosulfonates, naphthalene sulfonates, alkylnaphtalene sulfonates, benzylsulfonates, alkylbenzene sulfonates and the mixtures thereof.

14. An agrochemical suspension concentrate composition according to any of claims 1-13, further comprising an additive selected from selected from the group comprising dispersants, wetting agents, antifreezing agents, antifoaming agents, preservatives, surfactants, pH modifiers and stabilizers.

15. An agrochemical suspension concentrate composition according to any of claims 1-13, further comprising from about 0.5% to about 30% by weight of at least one another pesticidal active ingredient.

16. An agrochemical suspension concentrate composition according to claim 15, wherein at least one another pesticidal active ingredient is selected from abamectin, acetamiprid, amitraz, avermectin, azadirachtin, bifenthrin, buprofezin, cartap, chlorfenapyr, chlorpyrifos, clothianidin, cyfluthrin, beta-cyfluthrin, cyhalothrin, lambda-cyhalothrin, cypermethrin, cyromazine, deltamethrin, dieldrin, dinotefuran, diofenolan, emamectin, endosulfan, esfenvalerate. ethiprole, fenothiocarb, fenoxycarb, fenvalerate, fipronil, fionicamid, flufenoxuron, hexaflumuron, hydramethyhion, imidacloprid, indoxacarb, lufenuron, metaflumizone, methomyl, methoprene, methoxyfenozide, nitenpyram, nithiazine, novaluron, oxamyl, pymetrozine, pyrethrin, pyridaben, pyridalyl, pyriproxyfen, spinetoram, spirotetramate, spinosad, spirodiclofen, spiromesifen, tebufenozide, thiacloprid, thiamethoxam, thiodicarb, thiosultap-sodium, tralomethrin, triazamate, triflumuron.

17. A method for controlling an arthropod pest, comprising diluting a suspension concentrate composition according to any one of claims 1-13 with water, and optionally adding an adjuvant to form a diluted composition, and contacting the arthropod pest or its environment with an effective amount of said diluted composition.

18. A method for the protection of plant propagation material from the attack by a pest such as an insect, comprising treating the propagation material or the site where the propagation material is to be planted with an effective amount of a composition according to any one of claims 1-13.
